(19) United States
(12) Patent Application Publication
(10) Pub. No.: US 2015/0072540 A1
(43) Pub. Date: Mar. 12, 2015

(54) APPARATUS FOR HOUSING PLUG-IN UNIT AND PLUG-IN UNIT

(71) Applicant: FUJITSU LIMITED, Kawasaki-shi (JP)

(72) Inventor: Yuta SASAKI, Kawasaki (JP)

(73) Assignee: FUJITSU LIMITED, Kawasaki-shi (JP)

(21) Appl. No.: 14/460,551

(22) Filed: Aug. 15, 2014

(30) Foreign Application Priority Data
Sep. 11, 2013 (JP) 2013-188580

(51) Int. Cl. H01R 13/64; H01R 13/66

(52) U.S. Cl. CPC H01R 13/64; H01R 13/6683
USPC 439/38

(57) ABSTRACT

An apparatus for housing a plug-in unit that includes at least one movable piece including a permanent magnet in a portion of a casing. The apparatus includes a plurality of slots, each of the plurality of slots houses the plug-in unit; a connector provided in an inner or innermost portion of the slot and electrically connects with the plug-in unit; an advancement blocking member disposed within the slot and blocks connection of the plug-in unit to the connector by coming into contact with the movable piece; an electromagnet that generates a magnetic field applied to the permanent magnet of the plug-in unit; and a control device that controls the electromagnet so as to generate a magnetic field having a predetermined polarity that moves the movable piece of the plug-in unit to a position in which the movable piece does not come into contact with the advancement blocking member.

### CROSS-REFERENCE TO RELATED APPLICATION

This application is based upon and claims the benefit of priority of the prior Japanese Patent Application No. 2013-188580, filed on Sep. 11, 2013, the entire contents of which are incorporated herein by reference.

### FIELD

The embodiment discussed herein is related to an apparatus for housing a plug-in unit and a plug-in unit.

### BACKGROUND

Advancement in information apparatuses has achieved the practical use of apparatuses having a plug-in structure in which numerous packages and units with electronic circuits and storage devices are housed in shelves or slots in an insertable and removable manner. In an apparatus including a plug-in structure that is capable of housing units in a plurality of slots, a connector that exchanges electrical signals with the unit is provided in the back of each slot. When the unit is inserted into the slot, the unit is connected by a connector on the unit being plugged into the connector in the back of the slot. Such a unit is replaceable, and is also referred to as a replaceable unit or a plug-in unit.

Meanwhile, when the packages and units (referred to, hereinafter, as plug-in units) that are able to be inserted into and removed from the apparatus having a plug-in structure are of a single type, any plug-in unit may be attached to any slot. However, there are some apparatuses having a plug-in structure that allow attachment of a plurality of types of plug-in units with different functions.

Japanese Laid-open Patent Publication No. 8-316667 discloses a package-misinsertion prevention mechanism for enabling plug-in units that respectively correspond with the slots to be inserted without error in an apparatus having a plug-in structure that supports such a plurality of types of plug-in units. The apparatus disclosed in Japanese Laid-open Patent Publication No. 8-316667 is provided with a separate connector in a position in front of a normal insertion position. The separate connector is initially coupled with a package. During normal insertion, the separate connector sends a current to an electromagnet within the package and attracts a magnet in a movable piece, thereby drawing the movable piece into the package. Therefore, the package is directly inserted and coupled. On the other hand, during misinsertion, the separate connector does not send a current to the electromagnet within the package, and the movable piece remains projecting from the package. Therefore, the movable piece comes into contact with an insertion blocking section and insertion of the package is blocked.

In addition, to prevent a plug-in unit from being incorrectly inserted, there is also a unit-misinsertion prevention mechanism in which an obstruction, such as a pin, is provided in the slot of the apparatus having a plug-in structure or on a side surface of the plug-in unit. An example of this misinsertion prevention mechanism is illustrated in FIGS. 1A to 1D. As illustrated in FIG. 1A, a pin 92 is provided in a projecting manner in the innermost portion of a slot 91 in an apparatus having a plug-in structure 90. The pin 92 is attached at the factory in which the apparatus having a plug-in structure 90 is manufactured. As illustrated in FIG. 1C, the attachment position of the pin 92 differs depending on the type of plug-in unit 93 to be inserted into the slot 91. On the other hand, a key groove 94 is formed in an end portion of the plug-in unit 93 to be inserted into the slot 91. The setting position of the key groove 94 also differs depending on the type of plug-in unit 93.

FIG. 1A illustrates a state in which a correct plug-in unit 93 is inserted into a certain slot 91. In this instance, the position of the pin 92 and the position of the key groove 94 match. Therefore, in this instance, as illustrated in FIG. 1B, when the plug-in unit 93 is inserted into the slot 91, the pin 92 enters the key groove 94. As a result, the plug-in unit 93 is completely inserted into the slot 91. FIG. 1C illustrates a state in which an incorrect plug-in unit 93 is inserted into another slot 91A. In this instance, the position of the pin 92A and the position of the key groove 94 do not match. Therefore, in this instance, as illustrated in FIG. 1D, when the plug-in unit 93 is inserted into the slot 91A, the tip of the pin 92 comes into contact with the end surface of the plug-in unit 93 on which the key groove 94 is not provided. Therefore, the plug-in unit 93 is not inserted into the slot 91.

### SUMMARY

According to an aspect of the invention, an apparatus for housing a plug-in unit that includes at least one movable piece including a permanent magnet in a portion of a casing, the apparatus for housing a plug-in unit includes a plurality of slots, each of the plurality of slots houses the plug-in unit; a connector provided in an inner portion of the slot and electrically connects with the plug-in unit; an advancement blocking member disposed within the slot and blocks connection of the plug-in unit to the connector by coming into contact with the movable piece; an electromagnet that generates a magnetic field applied to the permanent magnet of the plug-in unit; and a control device that controls the electromagnet so as to generate a magnetic field having a predetermined polarity that moves the movable piece of the plug-in unit to a position in which the movable piece does not come into contact with the advancement blocking member.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a cross-sectional view of the structures of a slot in an apparatus having a plug-in structure and a plug-in unit that is compatible with the slot in a comparison structure, FIG. 1B is a cross-sectional view of a state in which the plug-in unit is mounted in the slot illustrated in FIG. 1A, FIG. 1C is a cross-sectional view of the structures of a slot in an apparatus having a plug-in structure and a plug-in unit that is not compatible with the slot in a comparison structure, and FIG. 1D is a cross-sectional view of a state in which the plug-in unit is not able to be mounted in the slot illustrated in FIG. 1C;

FIG. 2A is an explanatory diagram of a disk array and a hard disk device to be housed in the disk array of the present application, FIG. 2B is a perspective view of a first example of a misinsertion prevention mechanism that is mounted in the hard disk device illustrated in FIG. 2A, and FIG. 2C is a side view of the misinsertion prevention mechanism of the first example illustrated in FIG. 2B;

FIG. 3A is a side view of a misinsertion prevention mechanism in a first variation example of the first example illustrated in FIG. 2C, and FIG. 3B is a side view of a misinsertion prevention mechanism in a second variation example of the first example illustrated in FIG. 2C;

FIG. 4A is a perspective view of an internal structure of a slot in the disk array illustrated in FIG. 2A that houses the hard disk device illustrated in FIGS. 2B and 2C, and FIG. 4B is a side view of the slot illustrated in FIG. 4A;

FIG. 5A is a side view of the slot illustrated in FIG. 4B and the hard disk device including the misinsertion prevention mechanism of the first example,

FIG. 5B is a side view of a state in which the hard disk device illustrated in FIG. 5A is inserted into the slot, and FIG. 5C is a side view of an operation of the misinsertion prevention mechanism when the hard disk device illustrated in FIG. 5A is inserted into a slot with which the hard disk does not correspond;

FIG. 6A is a side view of an operation of the misinsertion prevention mechanism when the hard disk device that is inserted into a slot corresponds with the slot, and FIG. 6B is a side view of a coupling operation of connectors when the hard disk device that is inserted into a slot corresponds with the slot;

FIG. 7A is an explanatory diagram for explaining a process in which the misinsertion prevention mechanism of the first example operates by electromagnets within a slot when the hard disk device that is inserted into the slot corresponds with the slot, and FIG. 7B is an explanatory diagram for explaining a process in which the misinsertion prevention mechanism of the first variation example of the first example operates by electromagnets within a slot when the hard disk device that is inserted into the slot corresponds with the slot;

FIG. 8A is a partial side view of a configuration of a misinsertion prevention mechanism of a second example of the present application that is provided in a hard disk device and a configuration of a corresponding slot, FIG. 8B is a partial side view of an operation of the misinsertion prevention mechanism of the second example when a hard disk device that does not correspond with the slot illustrated in FIG. 8A is inserted, FIG. 8C is a partial side view of an operation of the misinsertion prevention mechanism of the second example when a hard disk device that corresponds with the slot illustrated in FIG. 8A is inserted, and FIG. 8D is a partial side view of the final position of the hard disk device relative to the slot when the hard disk device that is inserted into the slot corresponds with the slot;

FIG. 9A is a partial side view of a configuration of a misinsertion prevention mechanism of a third example of the present application that is provided in a hard disk device and a configuration of a corresponding slot, FIG. 9B is a partial side view of an operation of the misinsertion prevention mechanism of the third example and the final position of the hard disk device relative to the slot when the hard disk device that is inserted into the slot corresponds with the slot, and FIG. 9C is a partial side view of an operation of the misinsertion prevention mechanism of the third example when the hard disk device illustrated in FIG. 9A does not correspond with the slot;

FIG. 10A is a perspective view of an outer appearance of a hard disk device that is housed in a disk array, FIG. 10B is a cross-sectional view taken along a virtual line XB when two misinsertion prevention mechanisms are mounted in the hard disk device illustrated in FIG. 10A, FIG. 10C is a cross-sectional view taken along a virtual line XC when three misinsertion prevention mechanisms are mounted in the hard disk device illustrated in FIG. 10A, FIG. 10D is a cross-sectional view taken along a virtual line XD when four misinsertion prevention mechanisms are mounted in the hard disk device illustrated in FIG. 10A, FIG. 10E is a table indicating the combinations of the polarities of electromagnets and permanent magnets when two misinsertion prevention mechanisms are provided, and FIG. 10F is a table indicating the number of misinsertion prevention mechanisms to be mounted and the number of combinations of polarity patterns;

FIG. 11A is a side view of a configuration of a misinsertion prevention mechanism of a fourth example of the present application that is provided in a replaceable unit and a configuration of a corresponding slot, and FIG. 11B is a partial side view of an operation of the misinsertion prevention mechanism of the fourth example when the replaceable unit illustrated in FIG. 11A does not correspond with the polarity of the electromagnets;

FIG. 12A is a partial side view of another operation of the misinsertion prevention mechanism of the fourth example when the replaceable unit illustrated in FIG. 11A does not correspond with the polarity of the electromagnets, FIG. 12B is a partial side view of an operation of the misinsertion prevention mechanism of the fourth example when the replaceable unit illustrated in FIG. 11A corresponds with the polarity of the electromagnets, and FIG. 12C is a partial side view of an operation of the misinsertion prevention mechanism of the fourth example and the final position of the replaceable unit relative to the slot when the replaceable unit illustrated in FIG. 11A corresponds with the polarity of the electromagnets;

FIG. 13A is a side view of an example in which an insertion detecting device for a hard disk device is provided in the slot illustrated in FIG. 4B of the present application, FIG. 13B is an enlarged partial side view of a state in which the hard disk device approaches the insertion detecting device illustrated in FIG. 13A, and FIG. 13C is an enlarged partial side view of a state in which the hard disk device is further inserted into the slot from the state illustrated in FIG. 13B and the insertion detecting device is in operation;

FIG. 14 is a block circuit diagram of an overall configuration of an apparatus for housing a plug-in unit of the present application in which the insertion detecting device is not provided in the slot;

FIG. 15 is a block circuit diagram of an overall configuration of the an apparatus for housing a plug-in unit of the present application in which the insertion detecting device is provided in the slot;

FIG. 16 is a flowchart for explaining the procedure in a factory initial setting process that is performed at a factory of the apparatus for housing a plug-in unit of the present application in which the insertion detecting device is not provided in the slot;

FIG. 17 is a flowchart for explaining the procedure in the factory initial setting process performed at the factory of the apparatus for housing a plug-in unit of the present application in which the insertion detecting device is provided in the slot;

FIG. 18 is a flowchart for explaining the procedure of in-field active maintenance of the apparatus for housing a plug-in unit of the present application in which the insertion detecting device is not provided in the slot; and

FIG. 19 is a flowchart for explaining the procedure of in-field active maintenance of the apparatus for housing a plug-in unit of the present application in which the insertion detecting device is provided in the slot.

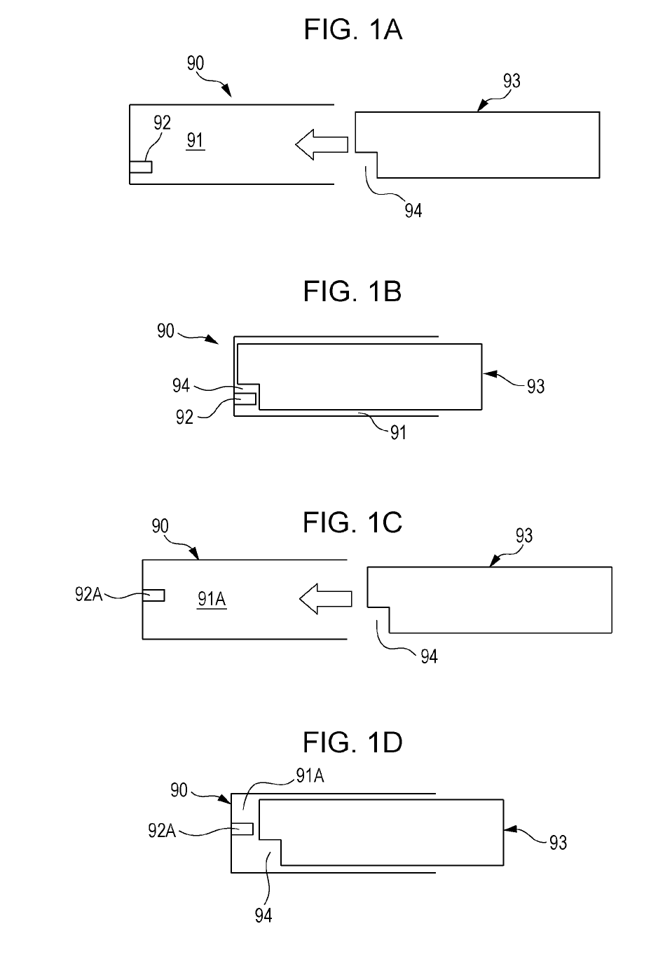

### DESCRIPTION OF EMBODIMENT

In the package-misinsertion prevention mechanisms of related art, when the combination of a slot and the plug-in unit that is correctly inserted into and removed from the slot is to be changed after manufacturing, a worker has to manually replace the structure with a structure that enables replacing. A structure that enables replacing is generally provided in the back of the slot. When a plurality of slots are present, a problem occurs in that the number of man-hours in the replacement operation is large and mistakes may occur during the replacement. When misinsertion occurs as a result of mistakes during replacement, a problem also occurs in that time has to be used for recovery.

From one perspective, by attaching a permanent magnet on the plug-in unit side such that the polarity is based on the type of plug-in unit and providing an electromagnet of which the polarity is able to be changed on the plug-in unit side, the present application aims to provide an apparatus for housing a plug-in unit, which is capable of supporting changes in the type of plug-in unit. In addition, from another perspective, the present application aims to provide a plug-in unit that is able to be inserted into a slot of an apparatus for housing the plug-in unit, which includes, within the slot, an electromagnet of which the polarity is able to be changed.

Hereinafter, embodiments of the present disclosure will be described in detail based on specific examples, with reference to the accompanying drawings. In the examples described hereafter, a disk array is described as an apparatus for housing a plug-in unit (hereinafter also referred to as a housing apparatus) and a hard disk device is described as a plug-in unit. However, the present application is not limited thereto. In other words, as examples of the plug-in unit, a magnetic tape device, an optical disc device, a semiconductor memory device (SSD), and the like may be given, in addition to the hard disk device. The plug-in unit does not have to be a unit having the same physical shape as long as the plug-in unit is able to be inserted into a slot without changing the slot for the plug-in unit in the housing apparatus.

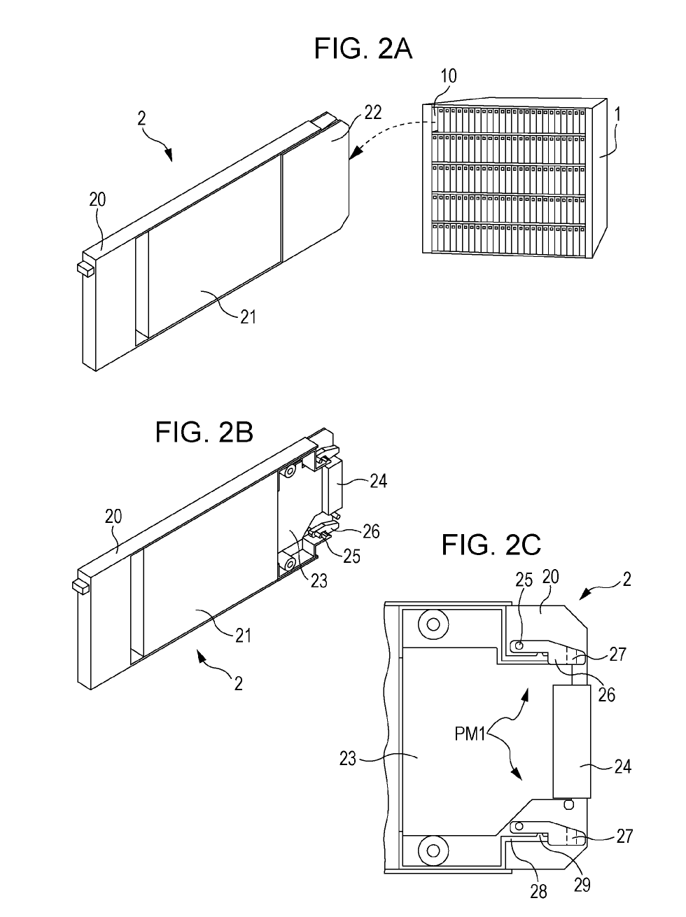

FIG. 2A illustrates a disk array 1 as an example of the apparatus for housing a plug-in unit of the present application and a hard disk device 2 as an example of a plug-in unit that is housed in the housing apparatus. The disk array 1 is provided with a plurality of slots 10 that are elongated in a vertical direction and are each capable of housing therein the hard disk device 2. For example, 80 slots 10 are provided. The hard disk device 2 that is housed in the slot 10 is able to be inserted and removed, and is replaceable. The hard disk device 2 includes a casing 20. A hard disk device main body 21 is provided in the center portion of the casing 20. A circuit board 23 on which a connector 24 is mounted as illustrated in FIG. 2B is provided on the insertion-end side of the hard disk device 2 to be inserted into the slot 10. The circuit board 23 including the connector 24 is covered by a cover 22 as illustrated in FIG. 2A. The hard disk device 2 is easily inserted into the slot 10.

FIG. 2C illustrates a misinsertion prevention mechanism PM1 on the hard disk device-side of the first example of the present application, the misinsertion prevention mechanism PM1 being provided on the insertion-end side of the hard disk device 2 to be inserted into the slot 10 illustrated in FIG. 2B. Ribs 28 are provided on both sides of the circuit board 23 in the casing 20 on the insertion-end side of the hard disk device 2 to be inserted into the slot 10. Two arms 26 are provided as movable pieces in the misinsertion prevention mechanism PM1 on the hard disk device-side of the first example, each arm 26 being capable of swinging around a rotation shaft 25 that is provided in a projecting manner in the casing 20. A permanent magnet 27 is embedded near the tip of each arm 26. The rotation shaft 25 of the arm 26 on the upper side is provided in a projecting manner in the casing 20, on the outer side of the rib 28. The rotation shaft 25 of the arm 26 on the lower side is provided in a projecting manner in the casing 20, in a section between the rib 28 and the circuit board 23. A reason for this is to allow each arm 26 to be supported by a stopper 29 provided in the rib 28 by dropping naturally, because the hard disk device 2 is inserted into the disk array 1 in a vertically standing state as illustrated in FIG. 2A.

The two arms 26 that are each supported by the stopper 29 provided in the rib 28 are parallel with the length direction of the hard disk device 2. In this state, the polarity of the permanent magnet 27 embedded near the tip of the arm 26 is in a direction perpendicular to the length direction of the hard disk device 2. Either of the N pole and the S pole of the permanent magnet 27 may face the outer side of the hard disk device 2.

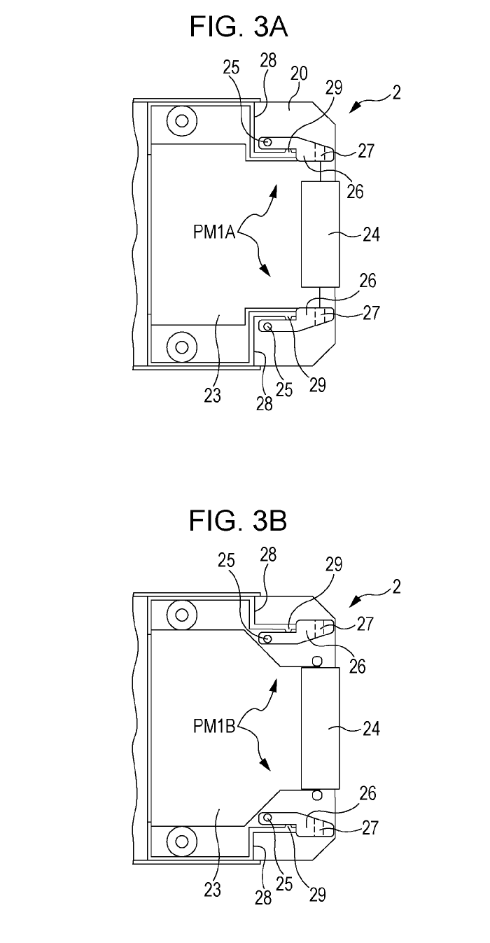

In the misinsertion prevention mechanism PM1 on the hard disk device-side of the first example, the rotation shaft 25 of the arm 26 on the upper side is provided in a projecting manner in the casing 20, on the outer side of the rib 28. The rotation shaft 25 of the arm 26 on the lower side is provided in a projecting manner in the casing 20, in a section between the rib 28 and the circuit board 23. On the other hand, a misinsertion prevention mechanism PM1A of a first variation example of the first example illustrated in FIG. 3A is possible in which the rotation shafts 25 of the arms 26 on the upper and lower sides are both provided in a projecting manner in the casing 20, on the outer sides of both ribs 28. An misinsertion prevention mechanism PM1B of a second variation example of the first example illustrated in FIG. 3A is also possible in which the rotation shafts 25 of the arms 26 on the upper and lower sides are both provided in a projecting manner in the casing 20, in the sections between the ribs 28 and the circuit board 23.

However, in the misinsertion prevention mechanism PM1A in the first variation example of the first example, to enable the arm 26 on the lower side to come into contact with the stopper 29 provided in the rib 28, a spring (not illustrated) for rotating the arm 26 upwards has to be used between the rotation shaft 25 and the arm 26. In addition, in the misinsertion prevention mechanism PM1B in the second variation example of the first example, to enable the arm 26 on the upper side to come into contact with the stopper 29 provided in the rib 28, a spring (not illustrated) for rotating the arm 26 upwards has to be used between the rotation shaft 25 and the arm 26. Furthermore, when the hard disk device 2 is inserted horizontally in a disk array that is provided with laterally elongated slots, a spring may be provided between all rotation shafts 25 and arms 26 to enable each arm 26 to come into contact with the stopper 29 provided in the rib 28.

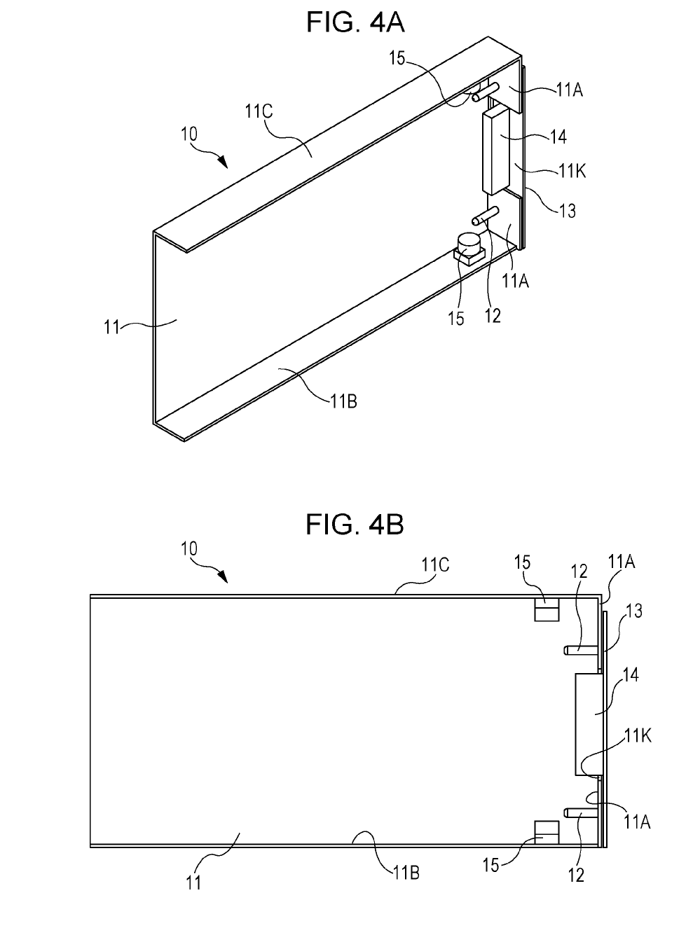

FIGS. 4A and 4B illustrate a first example of an internal structure of the slot 10 in the disk array 1 illustrated in FIG. 2A. The internal structure corresponds with the hard disk device 2 including the misinsertion prevention mechanism PM1 of the first example illustrated in FIGS. 2B and 2C. The internal structure of the slot 10 illustrated in FIGS. 4A and 4B also correspond with the first variation example PM 1A and the second variation example PM 1B of the misinsertion prevention mechanism of the first example illustrated in FIGS. 3A and 3B.

As illustrated in FIGS. 4A and 4B, the slot 10 is formed so as to be surrounded by a single partition wall 11 and three side walls 11A, 11B, and 11C. The portion of the slot 10 in which the side walls 11A, 11B, and 11C are not present serves as an entry portion for the hard disk device 2. In addition, the portion opposing the partition wall 11 is partitioned by the partition wall 11 of the adjacent slot 10. The side wall 11A is provided in the innermost portion of the slot 10, and is provided with a cut-out section 11K in the center portion. A back plate 13 is provided on the outer side of the side wall 11A. A connector 14 that is mounted on the back plate 13 projects into the slot 10 from the cut-out section 11K. Pins 12 that project into the slot 10 are provided on the side wall 11A on both sides of the cut-out section 11K.

In addition, the side wall 11B serves as the bottom wall of the slot 10, and the side wall 11C serves as the ceiling wall of the slot 10. Electromagnets 15 are provided so as to oppose each other on the inner sides of the side walls 11B and 11C, near the tips of the pins 12 provided in a projecting manner on the side wall 11A. The direction of the magnetic fields generated by the electromagnets 15 is a direction perpendicular to the length direction of the slot 10. The electromagnet 15 may or may not include an iron core. The structure of electromagnets is well known. Therefore, an illustration of the structure of the electromagnet 15 is omitted. In addition, a structure is also possible in which the electromagnets 15 are disposed on the outer sides of the side walls 11B and 11C and the iron cores (yokes) of the electromagnets 15 are project towards the inner sides of the side walls 11B and 11C.

Each electromagnet 15 is connected to a control unit (described hereafter) that is provided within the disk array 1 illustrated in FIG. 2A. The electromagnet 15 receives a current from the control unit, thereby generating a magnetic field that is suitable for a valid hard disk device 2 that is inserted to the slot 10. Therefore, in the control unit, control values prescribing the direction and the amount of the current to be provided to the electromagnet 15 are set in advance. The control values that are set in the control unit may be inputted by a host computer that is connected to the disk array 1, an external input device, or the like. Therefore, when the type of hard disk device 2 to be inserted into a certain slot 10 is changed, the hard disk device 2 after the change in type is able to be validated by the control values prescribing the direction and the amount of the current to be provided to each electromagnet 15 in the slot 10 being changed.

In addition, in the misinsertion prevention mechanism PM1 of the first example, the electromagnetic attractive force or the electromagnetic repulsive force between the permanent magnets 27 and the electromagnets 25, and the length and weight of the arms 26 are set to enable the driving force for rotating the arms 26 to be obtained. Furthermore, in the misinsertion prevention mechanisms PM 1A and PM 1B of the first and second variation examples of the first example and when the hard disk device 2 is to be horizontally inserted, a spring constant that enables the arm 26 to be rotated by the electromagnet 15 is set for the spring provided between the rotation shaft 25 and the arm 26.

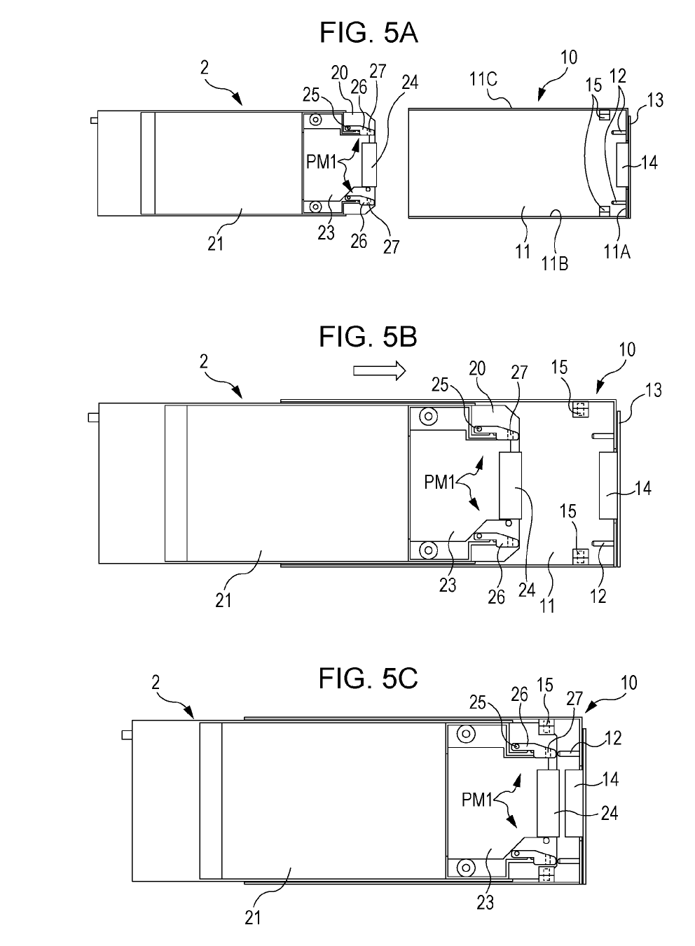

FIG. 5A illustrates a state immediately before the hard disk device 2 including the misinsertion prevention mechanism PM1 of the first example is inserted into the slot 10 illustrated in FIG. 4B. When the hard disk device 2 is inserted into the slot 10 from the state illustrated in FIG. 5A, the state becomes that illustrated in FIG. 5B. In the state illustrated in FIG. 5B, the end portion of the hard disk device 2 is advancing forward but has not yet reached the electromagnets 15.

In the state illustrated in FIG. 5B, a situation may be considered in which the hard disk device 2 that has been inserted into the slot 10 is incorrect and unsuitable for the slot 10. Energization of the electromagnets 15 is started before the hard disk device 2 is inserted or while the hard disk device 2 is advancing forward. At this time, even when the magnetic fields of the electromagnets 15 are applied to the permanent magnets 27 of the misinsertion prevention mechanism PM1 provided in the end portion of the hard disk device 2, the polarity of the permanent magnet 27 and the polarity of the magnetic field of the electromagnet 15 are not compatible. Consequently, the force for rotating the arms 26 is not able to be obtained. Therefore, the arms 26 of the misinsertion prevention mechanism PM1 do not swing and remain in the initial state. In this state, when the hard disk device 2 is further advanced into the slot 10, the tips of the two arms 26 come into contact with the tips of the two pins 12. At the position at which the tips of the two arms 26 come into contact with the tips of the two pins 12, the connector 24 provided in the hard disk device 2 is not coupled with the connector 14 provided in the back plate 14. In this way, an incorrectly inserted hard disk device 2 is not connected to the back plate 13.

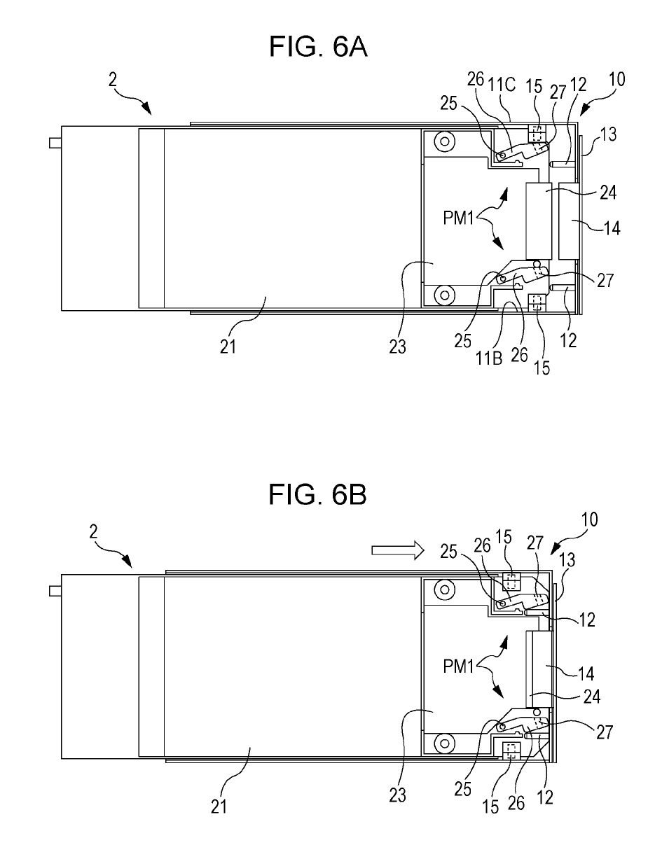

Next, in the state illustrated in FIG. 5B, a situation may be considered in which the hard disk device 2 that is inserted into the slot 10 is correct and suitable for the slot 10. Energization of the electromagnets 15 is started before the hard disk device 2 is inserted or while the hard disk device 2 is advancing forward. In this instance, as illustrated in FIG. 6A, the permanent magnets 27 of the misinsertion prevention mechanism PM1 provided at the end portion of the hard disk device 2 are affected by the magnetic fields of the electromagnets 15. Therefore, each arm 26 rotates and moves to a retreated position. A reason for this is that, in the correct hard disk device 2, because the polarity of the permanent magnet 27 and the polarity of the electromagnetic field of the electromagnet 15 are compatible, the force that enables the arm 26 in the misinsertion prevention mechanism PM1 to be rotated by the electromagnet 15 is able to be obtained.

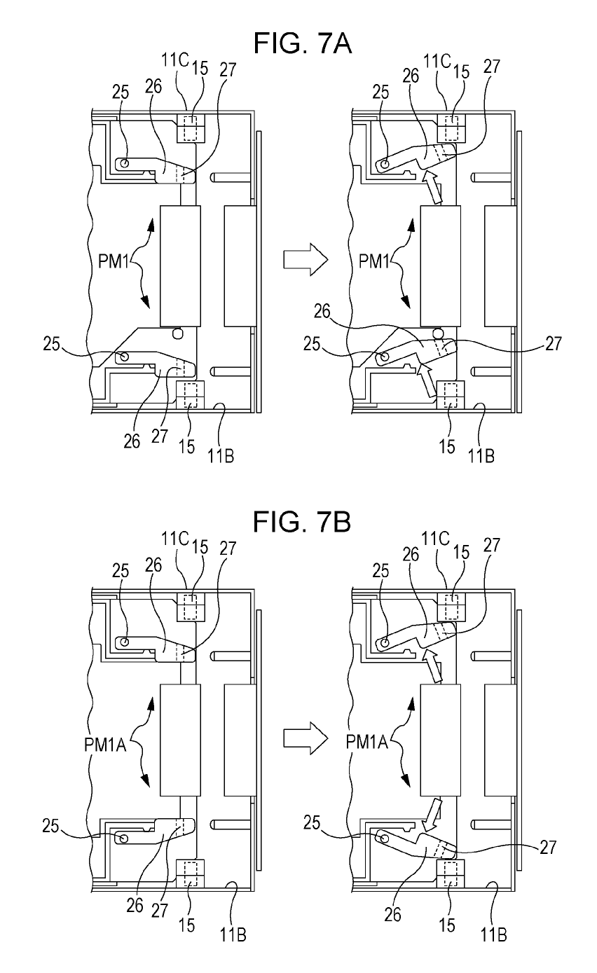

The directions of the magnetic fields generated by the electromagnets 15 when the hard disk device 2 that is inserted into the slot 10 is correct and suitable for the slot 10 will be described with reference to FIG. 7A. The electromagnet 15 on the upper side generates a magnetic field that attracts the permanent magnet 27 within the arm 26 on the upper side. Conversely, the electromagnet 15 on the lower side generates a magnetic field that repels the permanent magnet 27 within the arm 26 on the lower side. As a result, the arm 26 on the upper side is attracted to the electromagnet 15 on the upper side, and the arm 26 on the lower side moves in a direction away from the electromagnet 15 on the lower side.

When the hard disk device 2 is further inserted into the slot 10 from the state illustrated on the right side in FIG. 7A, the state illustrated in FIG. 6A is reached, followed by the state illustrated in FIG. 6B. The connector 24 attached to the circuit board 23 is coupled with the connector 14 attached to the back plate 13. In other words, the arms 26 on the upper and lower sides provided in the hard disk device 2 rotate and retreat from the pins 12 by the magnetic fields of the electromagnets 15. Therefore, the pins 12 enter the spaces from which the arms 26 have moved, and the hard disk device 2 may be moved to the innermost portion of the slot 10.

The control values for the electromagnets 15 provided within the slot 10 are set such that, for the hard disk device 2 including the misinsertion prevention mechanism PM1, the electromagnet 15 on the upper side generates a magnetic field that attracts the permanent magnet 27, and the electromagnet 15 on the lower side generates a magnetic field that repels the permanent magnet 27. On the other hand, when the hard disk device 2 includes the misinsertion prevention mechanism PM 1A of the first variation example of the first example, as illustrated in FIG. 7B, the control values are set such that both electromagnets 15 on the upper and lower sides generate magnetic fields that attract the permanent magnets 27. In addition, when the hard disk device 2 includes the misinsertion prevention mechanism PM1B of the second variation example of the first example, the control values are set such that both electromagnets 15 on the upper and lower sides generate magnetic fields that repel the permanent magnets 27 (not illustrated).

As described above, in the disk array 1 in which the hard disk device 2 including the misinsertion prevention mechanism PM1 of the first example is housed in the slot 10, the polarity of the magnetic field generated by the electromagnet 15 is determined in advance based on the polarity of the permanent magnet 27 embedded in the arm 26. Therefore, when a hard disk device 2 is inserted into the slot 10 of which the polarity of the permanent magnet 27 is not compatible with the polarity of the electromagnet 15, the arm 26 does not move and the hard disk device 2 is not able to be inserted into the slot 10. On the other hand, even when the type of hard disk device 2 to be inserted into the slot 10 of the disk array 1 is changed, the polarities of the electromagnets 15 within the slot 10 are able to be changed by the control values set in the control units being changed, thereby enabling changes in type to be supported.

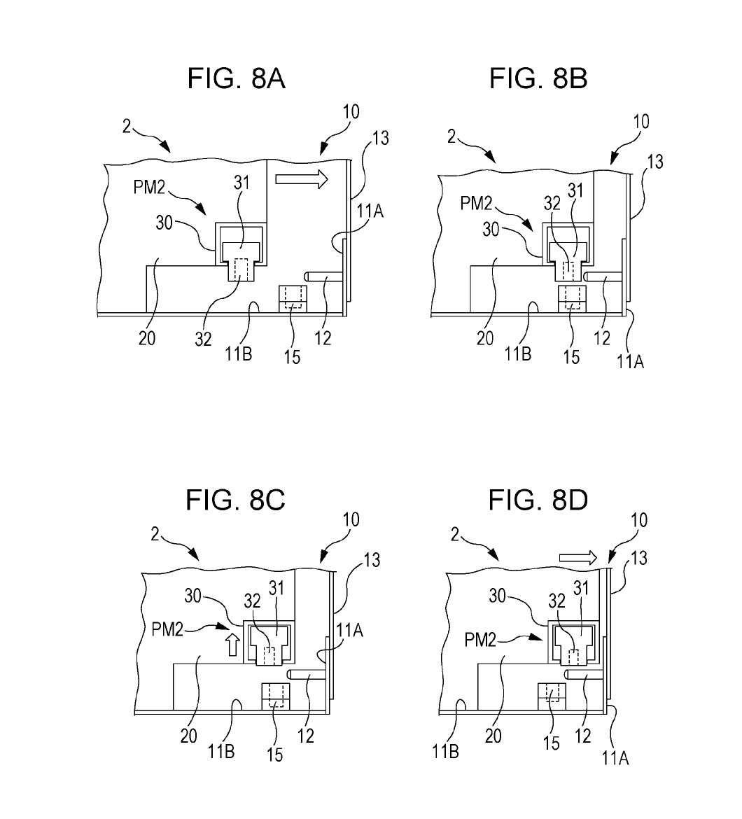

FIG. 8A illustrates a configuration of a misinsertion prevention mechanism PM2 of a second example of the present application provided in the hard disk device 2 and a configuration of a corresponding slot 10 in the disk array 1. The misinsertion prevention mechanism PM2 is provided on the lower side and the upper side of the insertion end of the hard disk device 2, or on either the lower side or the upper side. The movable piece in the misinsertion prevention mechanism PM2 is a slide rod 31 that emerges from a rod case 30. A permanent magnet 32 is embedded in the slide rod 31. When the misinsertion prevention mechanism PM2 is provided on the lower side of the insertion end of the hard disk device 2, the slide rod 31 projects from the rod case 30 by dropping naturally.

On the other hand, when the misinsertion prevention mechanism PM2 is provided on the upper side of the insertion end of the hard disk device 2, the slide rod 31 ordinarily sinks into the rod case 30 by dropping naturally. Therefore, when the misinsertion prevention mechanism PM2 is provide on the upper side of the insertion end of the hard disk device 2, a spring is inserted within the rod case 30 to enable the tip of the slide rod 31 to project from the rod case 30. FIG. 8A illustrates only the misinsertion prevention mechanism PM2 on the lower side of the insertion end of the hard disk device 2. An illustration of the misinsertion prevention mechanism PM2 provided on the upper side of the insertion end of the hard disk device 2 is omitted.

Within the slot 10 corresponding with the hard disk device 2 including the misinsertion prevention mechanism PM2 of the second example, the pin 12 is provided on the side wall 11A in the innermost portion so as to come into contact with the side surface of the slide rod 31 that is projecting from the rod case 30. The second example is similar to the above-described first example in that a cut-out section is provided in the center portion of the side wall 11A and a connector that is mounted on the back plate 13 provided on the outer side of the side wall 11A projects into the slot 10 from the cut-out section. However, illustration of the cut-out section and the connector are omitted in FIG. 8A.

In addition, the electromagnet 15 is provided on the inner side of the side wall 11B that serves as the bottom wall of the slot 10, near the tip of the pin 12 provided in a projecting manner on the side wall 11A. The direction of the magnetic field generated by the electromagnet 15 is a direction perpendicular to the length direction of the slot 10. The electromagnet 15 may or may not include an iron core. The end portion of the electromagnet 15 is in a position that is not in contact with the side surface of the slide rod 31 that projects from the rod case 30. In the state illustrated in FIG. 8A, the end portion of the hard disk device 2 has not yet reached the electromagnet 15.

Here, in the state illustrated in FIG. 8A, a situation may be considered in which the hard disk drive 2 that is inserted into the slot 10 is incorrect and not suitable for the slot 10. Energization of the electromagnet 15 is started before the hard disk device 2 is inserted or while the hard disk device 2 is advancing forward. At this time, even when the magnetic field of the electromagnet 15 is applied to the permanent magnet 32 of the misinsertion prevention mechanism PM2 provided in the end portion of the hard disk device 2, the polarity of the permanent magnet 32 and the polarity of the magnetic field of the electromagnet 15 are not compatible. Consequently, the force for moving the slide rod 31 into the rod case 30 is not able to be obtained. Therefore, the slide rod 31 in the misinsertion prevention mechanism PM2 remains in the initial state in which the slide rod 31 is projecting from the rod case 30. In this state, when the hard disk device 2 is further advanced into the slot 10, as illustrated in FIG. 8B, the side surface of the slide rod 31 comes into contact with the tip of the pin 12. At the position at which the side surface of the slide rod 31 comes into contact with the tip of the pin 12, the connector provided in the hard disk device 2 is not coupled with the connector provided in the back plate 14. In this way, an incorrectly inserted hard disk device 2 is not connected to the back plate 13.

Next, in the state illustrated in FIG. 8A, a situation may be considered in which the hard disk device 2 that is inserted into the slot 10 is correct and suitable for the slot 10. Energization of the electromagnet 15 is started before the hard disk device 2 is inserted or while the hard disk device 2 is advancing forward. In this instance, as illustrated in FIG. 8C, the permanent magnet 32 of the misinsertion prevention mechanism PM2 provided at the end portion of the hard disk device 2 is affected by the magnetic field of the electromagnet 15. The direction of the magnetic field generated by the electromagnet 15 at this time is a direction enabling the slide rod 31 to sink into the rod case 30, or in other words, a direction that repels the permanent magnet 32. As a result, the slide rod 31 sinks into the rod case 30 by the magnetic field of the electromagnet 15.

When the hard disk device 2 is further inserted into the slot 10 from the state illustrated in FIG. 8C, because the pin 12 does not come into contact with the slide rod 31 that has sunk into the rod case 30, the hard disk device 2 may be moved to the innermost portion of the slot 10. The operation is also similar for the misinsertion prevention mechanism PM2 that is provided on the upper side of the insertion end of the hard disk device 2.

In the disk array 1 in which the hard disk device 2 including the misinsertion prevention mechanism PM2 is housed in the slot 10 as described above, the polarity of the magnetic field generated by the electromagnet 15 is determined in advance by a control value, based on the polarity of the permanent magnet 32 embedded in the slide rod 31. Therefore, when a hard disk device 2 is inserted into the slot 10 of which the polarity of the permanent magnet 32 is not compatible with the polarity of the electromagnet 15, the slide rod 31 does not sink into the rod case 30, and the hard disk device 2 is not able to be inserted into the slot 10. On the other hand, even when the type of hard disk device 2 changes and the polarity of the permanent magnet 32 changes, the polarity of the electromagnet 15 within the slot 10 is able to be changed by the control value set in the control unit being changed. Therefore, changes in type may be supported.

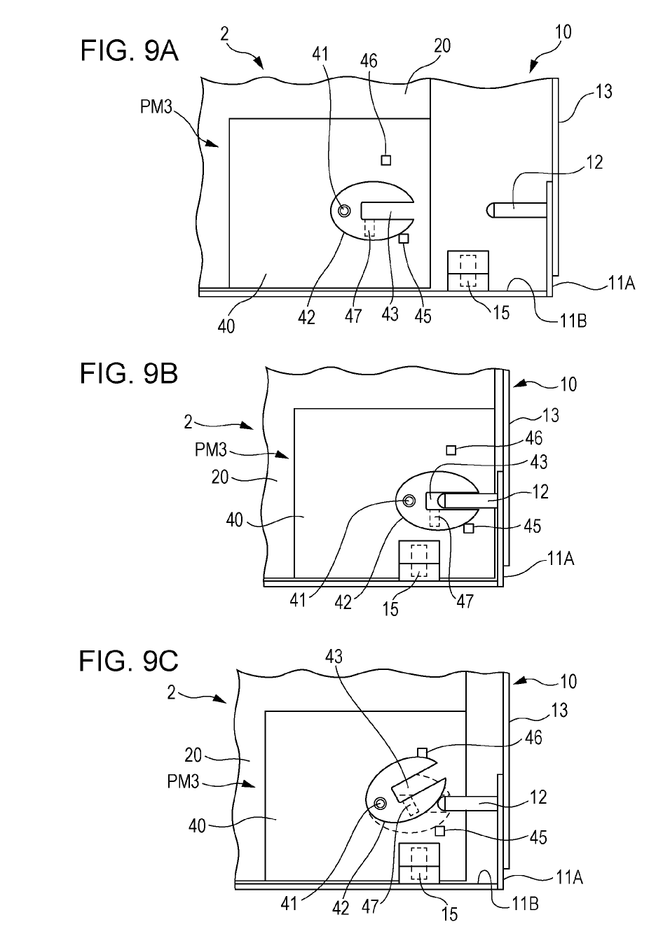

FIG. 9A illustrates a configuration of a misinsertion prevention mechanism PM3 of a third example of the present application provided in the hard disk device 2 and a configuration of a corresponding slot 10 in the disk array 1. The misinsertion prevention mechanism PM3 is provided on the lower side and the upper side of the insertion end of the hard disk device 2, or on either the lower side or the upper side. The movable piece in the misinsertion prevention mechanism PM3 is a cam 42 that swings in relation to a cam shaft 41 that is provided in a projecting manner on a cam base 40. A slit 43 is provided in a length-axis direction of the cam 42. A permanent magnet 47 is embedded within the cam 42 below the slit 43.

In addition, a first post 45 and a second post 46 are provided in the swinging range of the cam 42 to restrict the swinging range of the cam 42. When the misinsertion prevention mechanism PM3 is provided on the lower side of the insertion end of the hard disk device 2, the cam 42 drops naturally and is held by the first post 45. In a state in which the cam 42 is being held by the first post 45, the slit 43 that is provided in the cam 42 is parallel with the length direction of the slot 10. In a state in which the cam 42 is in contact with the second post 46, the slit 43 has a predetermined angle in relation to the length direction of the slot 10.

On the other hand, when the misinsertion prevention mechanism PM3 is provided on the upper side of the insertion end of the hard disk device 2, a misinsertion prevention mechanism PM3 similar to the misinsertion prevention mechanism PM3 illustrated in FIG. 9A may be provided on the upper side of the insertion end of the hard disk device 2. FIG. 9A illustrates only the misinsertion prevention mechanism PM3 on the lower side of the insertion end of the hard disk device 2. An illustration of the misinsertion prevention mechanism PM3 provided on the upper side of the insertion end of the hard disk device 2 is omitted.

Within the slot 10 corresponding with the hard disk device 2 including the misinsertion prevention mechanism PM3 of the third example, the pin 12 is provided on the side wall 11A in the innermost portion so as to enter the slit 43 that is provided in the cam 42. The third example is similar to the above-described first example in that a cut-out section is provided in the center portion of the side wall 11A and a connector that is mounted on the back plate 13 provided on the outer side of the side wall 11A projects into the slot 10 from the cut-out section. However, illustration of the cut-out section and the connector are omitted in FIG. 9A.

In addition, the electromagnet 15 is provided on the inner side of the side wall 11B that serves as the bottom wall of the slot 10, near the tip of the pin 12 provided in a projecting manner on the side wall 11A. The direction of the magnetic field generated by the electromagnet 15 is a direction perpendicular to the length direction of the slot 10. The electromagnet 15 may or may not include an iron core. The end portion of the electromagnet 15 is in a position that is not in contact with the first post 45 that is provided in a projecting manner on the cam base 40. In the state illustrated in FIG. 9A, the end portion of the hard disk device 2 has not yet reached the electromagnet 15.

Here, in the state illustrated in FIG. 9A, a situation may be considered in which the hard disk device 2 that is inserted into the slot 10 is correct and suitable for the slot 10. Energization of the electromagnet 15 is started before the hard disk device 2 is inserted or while the hard disk device 2 is advancing forward. At this time, as illustrated in FIG. 9B, even when the magnetic field of the electromagnet 15 is applied to the permanent magnet 47 of the misinsertion prevention mechanism PM3, the polarity of the permanent magnet 47 and the polarity of the magnetic field of the electromagnet 15 are not compatible. Consequently, the force for rotating the cam 42 is not able to be obtained. Therefore, the cam 42 in the misinsertion prevention mechanism PM3 does not swing and remains in the initial state in which the cam 42 is being held by the first post 45.

Therefore, when the hard disk device 2 is further inserted into the slot 10 from the state illustrated in FIG. 9A, the pin 12 that is provided in a projecting manner on the side wall 11A enters the slit 43 that is provided in the cam 42. As a result, the hard disk device 2 is may be moved to the innermost portion of the slot 10. The operation is also similar for the misinsertion prevention mechanism PM3 that is provided on the upper side of the insertion end of the hard disk device 2.

Next, in the state illustrated in FIG. 9A, a situation may be considered in which the hard disk drive 2 that is inserted into the slot 10 is incorrect and not suitable for the slot 10. Energization of the electromagnet 15 is started before the hard disk device 2 is inserted or while the hard disk device 2 is advancing forward. At this time, when the magnetic field of the electromagnet 15 is applied to the permanent magnet 47 of the misinsertion prevention mechanism PM3, because the polarity of the permanent magnet 47 and the polarity of the magnetic field of the electromagnet 15 are compatible, the force for rotating the cam 42 is able to be obtained. In other words, the electromagnet 15 generates a magnetic field having a polarity that is opposite of the polarity of the permanent magnet 47. As a result, the cam 42 rotates upwards around the cam shaft 41 until the outer peripheral portion of the cam 42 comes into contact with the second post 46. When the hard disk device 2 is further inserted into the slot 10 in a state in which the outer peripheral portion of the cam 42 is in contact with the second post 46, as illustrated in FIG. 9C, the outer peripheral portion of the cam 42 comes into contact with the tip of the pin 12. The hard disk device 2 is not able to be inserted any further. At the position at which the outer peripheral portion of the cam 42 is in contact with the tip of the pin 12, the connector provided in the hard disk device 2 is not coupled with the connector provided in the back plate 14. In this way, an incorrectly inserted hard disk device 2 is not connected to the back plate 13.

In the disk array 1 in which the hard disk device 2 including the misinsertion prevention mechanism PM3 is housed in the slot 10 as described above, the polarity of the magnetic field generated by the electromagnet 15 is determined in advance based on the polarity of the permanent magnet 47 in the cam 42, by a control value being set in the control unit. Therefore, when a hard disk device 2 is inserted into the slot 10 of which the polarity of the permanent magnet 47 is not compatible with the polarity of the electromagnet 15, the cam 42 rotates around the cam shaft 41, and the hard disk device 2 is not able to be inserted into the slot 10. On the other hand, even when the type of hard disk device 2 changes, the polarity of the electromagnet 15 within the slot 10 is able to be changed by the control value set in the control unit being changed. Therefore, changes in type are able to be supported.

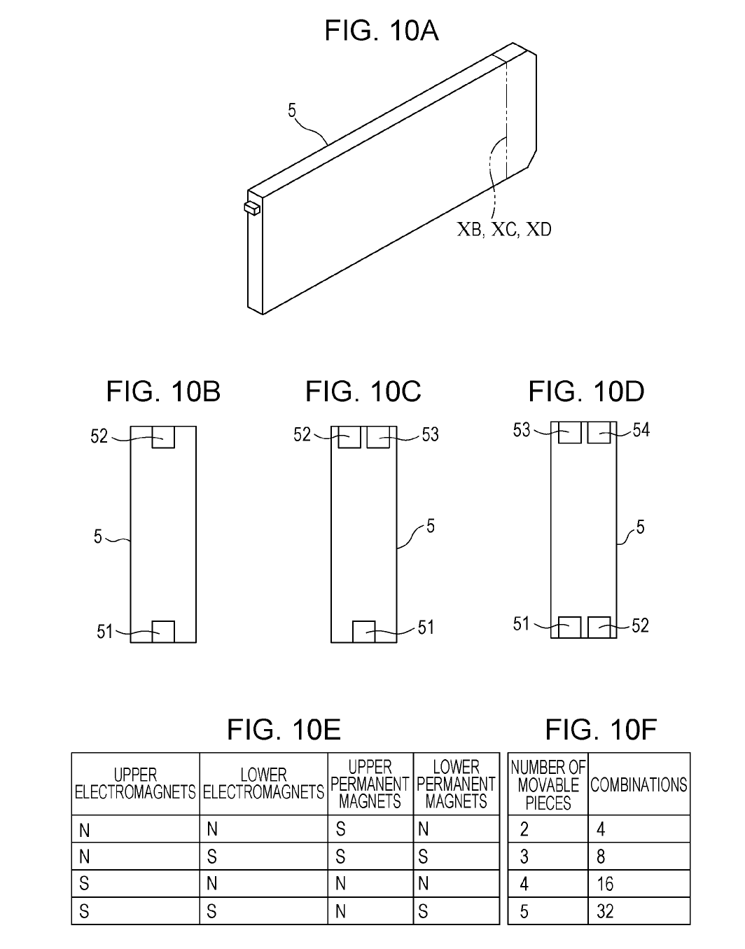

FIG. 10A illustrates an outer appearance of the replaceable unit 5 such as a hard disk device that is housed in a disk array. In the above-described examples of the hard disk device 2, a total of two movable pieces 51 and 52 that each include a permanent magnet are mounted, one on the lower end side and one on the upper end side of the replaceable unit 5, in a position in the replaceable unit 5 indicated by a virtual line XB, as illustrated in FIG. 10B. In this instance, there are four combinations of the upper electromagnet, the lower electromagnet, the upper permanent magnet, and the lower permanent magnet, as illustrated in FIG. 10E. Four replaceable unit 5 patterns are able to be created.

On the other hand, a total of three movable pieces 51 to 53 that each include a permanent magnet may be mounted, one movable piece 51 on the lower end side and two movable pieces 52 and 53 on the upper end side of the replaceable unit 5, in a position in the replaceable unit 5 indicated by a virtual line XC, as illustrated in FIG. 10C. In this instance, there are eight combinations of the upper electromagnets, the lower electromagnet, the upper permanent magnets, and the lower permanent magnet, as illustrated in FIG. 10F. Eight replaceable unit 5 patterns are able to be created.

Furthermore, a total of four movable pieces 51 to 54 that each include a permanent magnet may be mounted, two movable pieces 51 and 52 on the lower end side and two movable pieces 53 and 54 on the upper end side of the replaceable unit 5, in a position in the replaceable unit 5 indicated by a virtual line XD, as illustrated in FIG. 10D. In this instance, there are 16 combinations of the upper electromagnets, the lower electromagnets, the upper permanent magnets, and the lower permanent magnets, as illustrated in FIG. 10F. Sixteen replaceable unit 5 patterns are able to be created. When the number of movable pieces is increased, the types of replaceable unit 5 may be further increased. The polarities generated by the electromagnets disposed in positions corresponding with the movable pieces 51 to 54 that each include a permanent magnet may be set by control values being set in the control units.

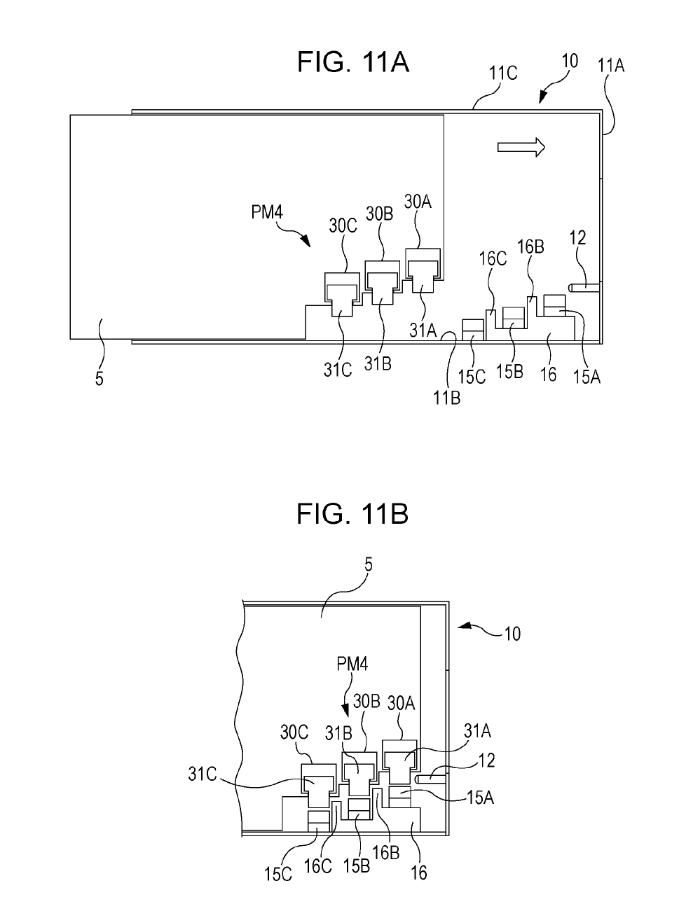

FIG. 11A illustrates a configuration of a misinsertion prevention mechanism PM4 of a fourth example of the present application provided in the replaceable unit 5 and an internal configuration of a corresponding slot 10. The misinsertion prevention mechanism PM4 is configured by three misinsertion prevention mechanisms PM2 of the second example being aligned in series at differing heights in the length direction of the slot 10. Therefore, the misinsertion prevention mechanism PM4 includes three rod cases 30A, 30B, and 30C, and slide rods 31A, 31B, and 31C that are housed within the rod cases 30A, 30B, and 30C. In the fourth example, the misinsertion prevention mechanism PM4 is only provided on the lower end side of the replaceable unit 5. However, the misinsertion prevention mechanism PM4 may also be provided on the upper end side.

Meanwhile, the pin 12 that is provided in a projecting manner on the side wall 11A, three electromagnets 15A, 15B, and 15C, and an attachment base 16 for the two electromagnets 15A and 15B are included within the slot 10. The electromagnet 15C is provided on the side wall 11B. The attachment base 16 is provided with a stopper 16C that comes into contact with the side surface of the slide rod 31C that projects from the rod case 30C and a stopper 16B that comes into contact with the side surface of the slide rod 31B that projects from the rod case 30B. In addition, the pin 12 is provided in a position that enables the pin 12 to come into contact with the side surface of the slide rod 31A that projects from the rod case 30A. The electromagnet 15B is positioned between the stopper 16B and the stopper 16C, and the electromagnet 15A is positioned between the stopper 16B and the pin 12.

Energization of the electromagnets 15A, 15B, and 15C is started before the replaceable unit 5 is inserted or while the replaceable unit 5 is advancing forward. First, when the polarities of all permanent magnets are not compatible with the polarities of the magnetic fields of the electromagnets 15A, 15B, and 15C, even when the magnetic fields of the electromagnets 15A, 15B, and 15C are applied, the force is not able to be obtained to move any of the slide rods 31A, 31B, and 31C into the rod cases 30A, 30B, and 30C. At this time, when the replaceable unit 5 is inserted into the slot 10, as illustrated in FIG. 11B, the pin 12 comes into contact with the side surface of the slide rod 31A that projects from the rod case 30A. In addition, the stopper 16B comes into contact with the side surface of the slide rod 31B that projects from the rod case 30B, and the stopper 16C comes into contact with the side surface of the slide rod 31C that projects from the rod case 30C.

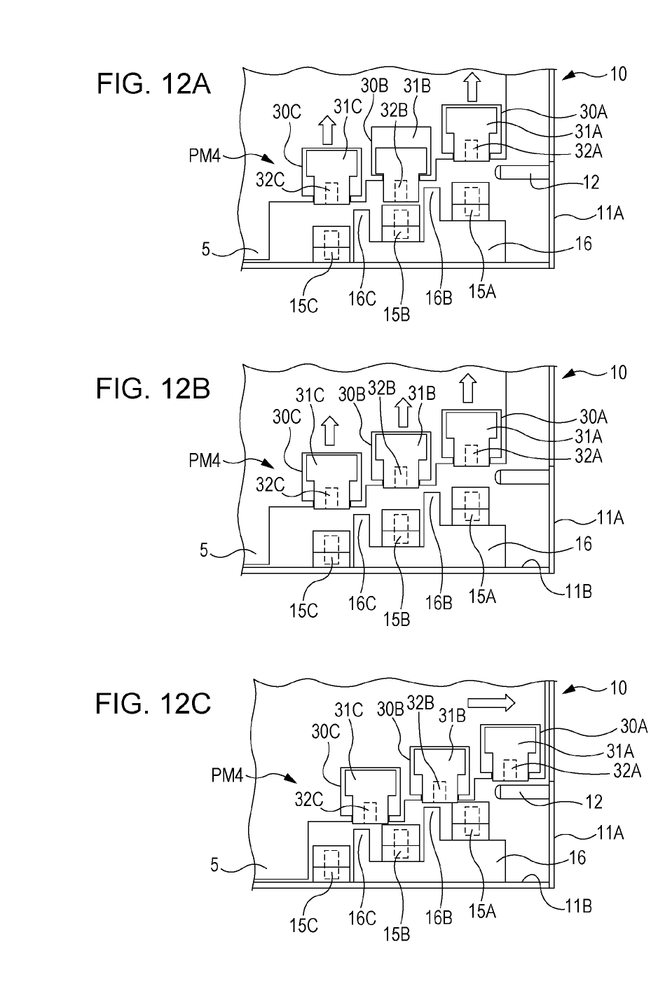

Next, when the polarities of all permanent magnets are not compatible with the polarity of the magnetic field of any one of the electromagnets 15A, 15B, or 15C, even when the magnetic fields of the electromagnets 15A, 15B, and 15C are applied, the force is not able to be obtained for moving one of the slide rods 31A, 31B, and 31C into the respective rod cases 30A, 30B, and 30C. Therefore, the slide rod 31A, 31B, or 31C of which the polarity of the permanent magnet is not compatible with the polarity of the magnetic field of the electromagnet 15A, 15B, or 15C does not move into the rod case 30A, 30B, or 30C, and comes into contact with a stopper 16B or 16C, or the pin 12. Therefore, the replaceable unit 5 is not able to be fully inserted. FIG. 12A illustrates when only the polarity of the permanent magnet in the slide rod 31B is not compatible with the polarity of the magnetic field of the electromagnet 15B. At this time, only the slide rod 31B that opposes the electromagnet 15B does not move into the rod case 30B and comes into contact with the stopper 16B. Therefore, the replaceable unit 5 is not able to be fully inserted.

Finally, when the polarities of all permanent magnets are compatible with the polarities of the magnetic fields of the electromagnets 15A, 15B, and 15C, when the magnetic fields of the electromagnets 15A, 15B, and 15C are applied, as illustrated in FIG. 12B, all slide rods 31A, 31B, and 31C sink into the rod cases 30A, 30B, and 30C. When the replaceable unit 5 is inserted into the slot 10 in this state, the replaceable unit 5 is able to move to the innermost portion of the slot 10.

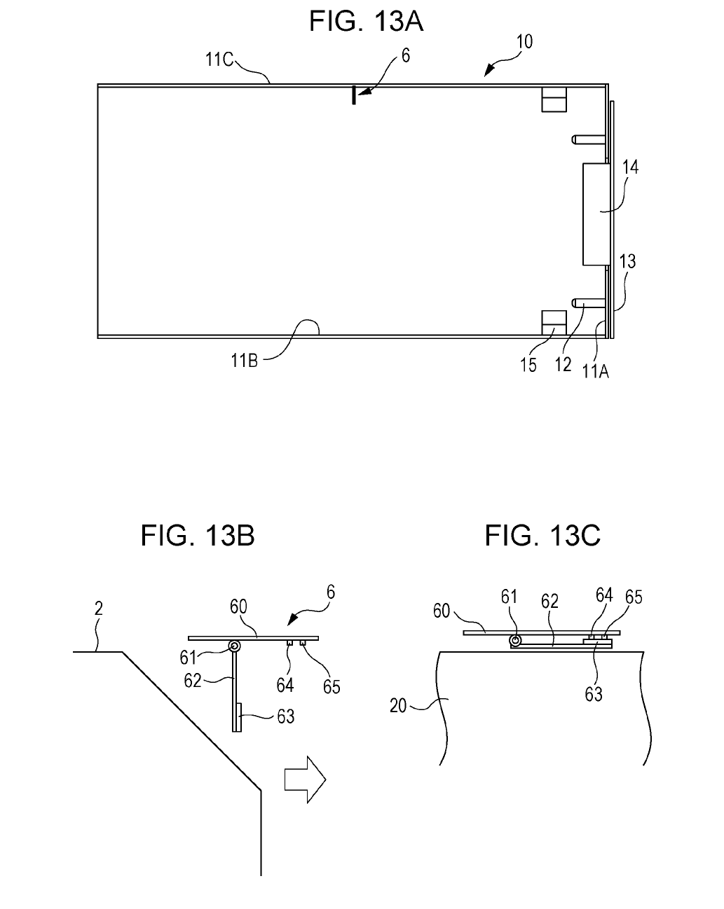

FIG. 13A illustrates an example in which a position sensor 6 that is an insertion detecting device for the hard disk device 2 is provided in the slot 10 illustrated in FIG. 4B of the present application. The position sensor 6 is provided in substantially the center portion of the slot 10. As illustrated in FIG. 13B, the position sensor 6 includes a sensor arm 62 on a rotation shaft 61 that is provided on a sensor base 60, a contact 63 being provided in the end portion of the sensor arm 62, and a first electrode 64 and a second electrode 65 that are provided on the sensor base 60. When the hard disk device 2 is inserted into the slot 10, the sensor arm 62 is pressed and rotates around the rotation shaft 61. The contact 63 provides conduction between the first electrode 64 and the second electrode 65. As a result, electric current flows between the first electrode 64 and the second electrode 65, and an electromagnet connected to the first electrode 64 and the second electrode 65 is turned on.

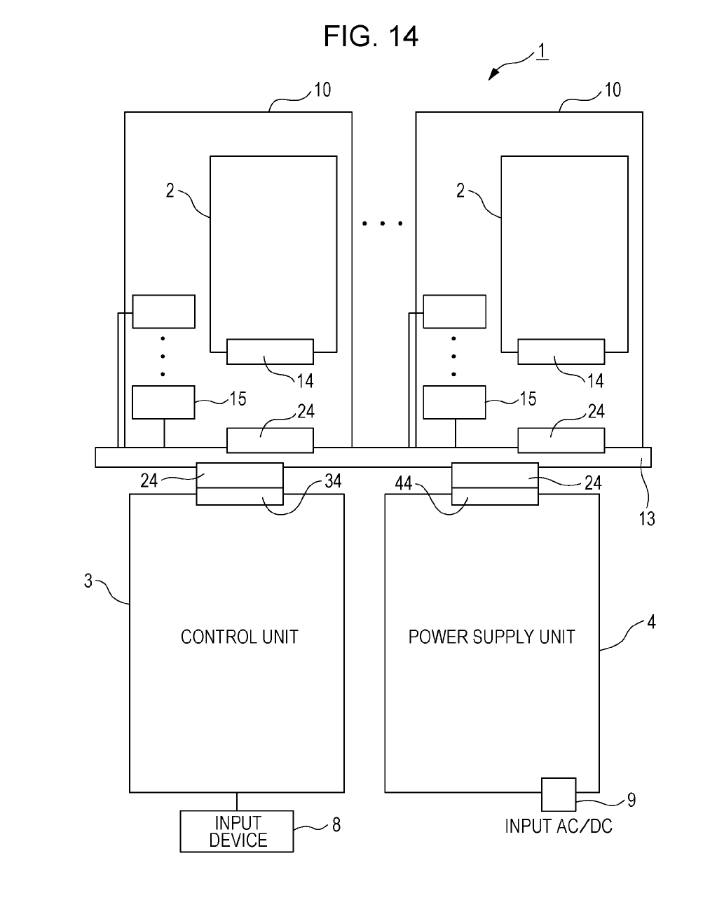

FIG. 14 is a block circuit diagram of an overall configuration of the apparatus for housing a plug-in unit (disk array 1) of the present application in which the position sensor 6 serving as an insertion detecting device is not provided in the slot 10. A plurality of connectors 24 are mounted on the back plate 13 that is provided within the disk array 1. A large portion of the connector 24 projects into the slot 10 of the disk array 1. In addition, a control unit 3 is connected to the connector 24 via a connector 34. A power supply unit 4 is also connected to the connector 24 via a connector 44. An input device 8 is connected to the control unit 3. The power supply unit 4 is connected to an alternating current (AC) power source or a direct current (DC) power source via an input terminal 9. The electromagnet 15 provided within the slot 10 is connected to the control unit 3 via the back plate 13. Energization taking into consideration the polarity of the magnetic field generated by the electromagnet 15 is performed based on a control value set in the control unit 3.

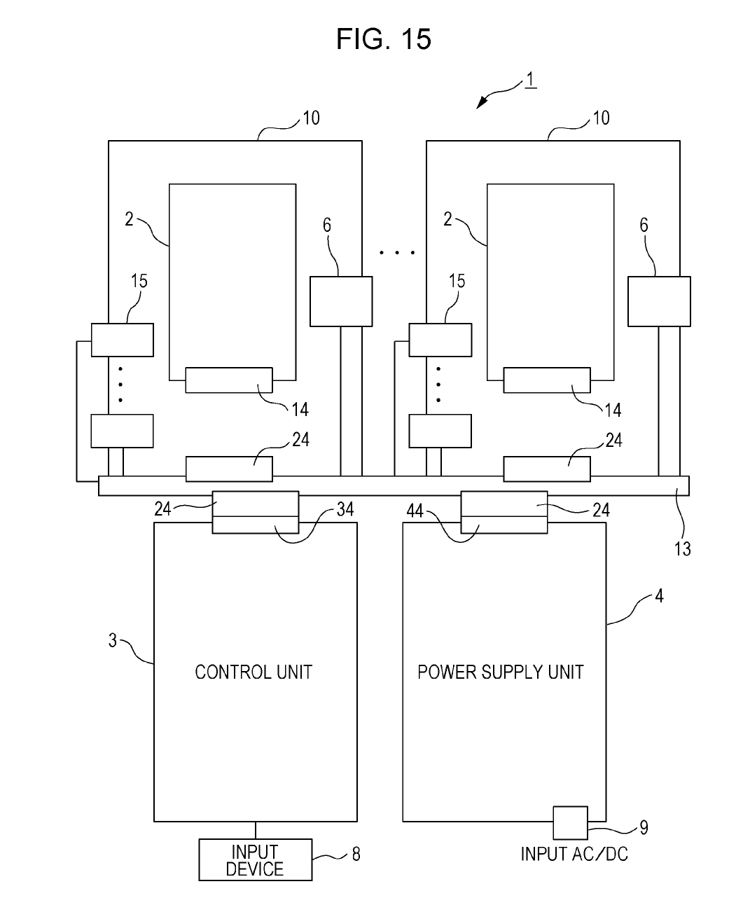

FIG. 15 is a block circuit diagram of an overall configuration of the apparatus for housing a plug-in unit (disk array 1) of the present application in which the position sensor 6 serving as an insertion detecting device is provided in the slot 10. Excluding the position sensor 6, the structure of the disk array 1 provided with the position sensor 6 is similar to that of the disk array 1 described with reference to FIG. 14. Therefore, the same constituent components are given the same reference symbols, and descriptions thereof are omitted.

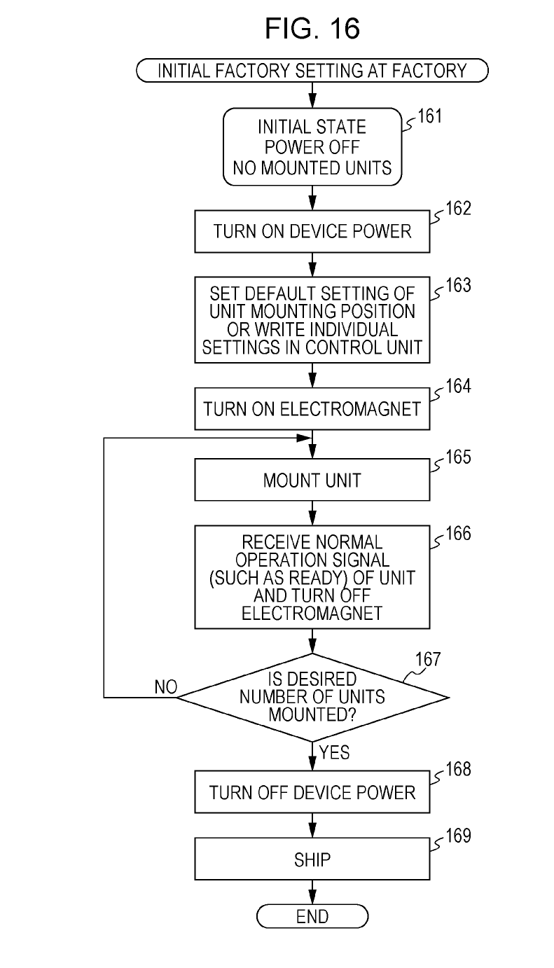

FIG. 16 is a flowchart for explaining the procedure in a factory initial setting process that is performed at a factory of the disk array of the present application in which a position sensor is not provided in a slot, such as that illustrated in FIG. 14. In an initial state indicated at step 161, the power is off and no units are mounted. At subsequent step 162, device power is turned on. At step 163, the default setting of the unit mounting position is set or individual settings are written in a memory area of the control unit. In this setting procedure, for example, a control table or the like is written in the memory area of the control unit, the control table in which the control values for controlling the direction of the current and the amount of current to be sent to the electromagnet are written in correspondence with the types of hard disk devices to be inserted into the respective slots. At subsequent step 164, all electromagnets in the disk array are turned on. At step 165, the hard disk devices that are plug-in units are mounted in all of the slots. At this time, when a hard disk device that is mounted in a slot is unsuitable, the polarity of the permanent magnet within the hard disk device and the polarity of the electromagnet within the slot that is based on the above-described control value are not compatible. Therefore, the unsuitable hard disk device is not able to be inserted into the slot.

At step 166, when a normal operation signal (such as a READY signal) of the mounted plug-in unit (hard disk device) is received, energization of the electromagnet in the slot is turned off. At step 167, whether or not the desired number of plug-in units (hard disk devices) has been mounted is determined. When the desired number of plug-in units (hard disk devices) has not been mounted, the procedure at step 165 to step S167 is repeated. Then, when determined at step 167 that the desired number of plug-in units (hard disk devices) has been mounted, the flow proceeds to step 168 and the device power is turned off. At step 169, the disk array is shipped.

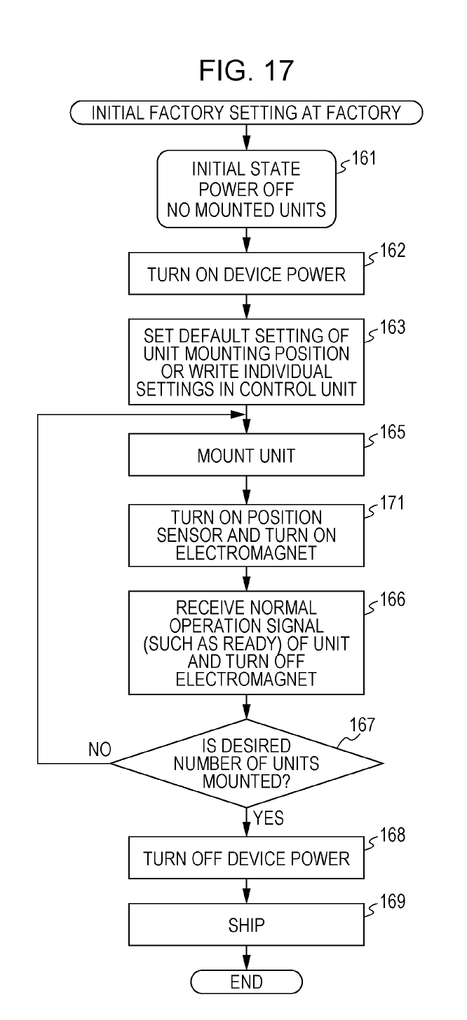

FIG. 17 is a flowchart for explaining the procedure in the factory initial setting process that is performed at a factory of the disk array of the present application in which a position sensor is provided in a slot, such as that illustrated in FIG. 15. The steps that are the same as those in FIG. 16 are described using the same step numbers. In the initial state indicated at step 161, the power is off and no units are mounted. At subsequent step 162, device power is turned on. At step 163, the default setting of the unit mounting position is set or individual settings are written in a memory area of the control unit. In this setting procedure, for example, a control table or the like is written in the memory area of the control unit, the control table in which the control values for controlling the direction of the current and the amount of current to be sent to the electromagnet are written in correspondence with the types of hard disk devices to be inserted into the respective slots. At subsequent step 165, the hard disk devices that are plug-in units are mounted in all of the slots.

As indicated at step 171, the position sensor is turned on when the hard disk device is mounted. Therefore, the electromagnet in the slot in which the hard disk device is mounted is turned on. At this time, when the hard disk device that is being mounted in the slot is unsuitable, the polarity of the permanent magnet within the hard disk device and the polarity of the electromagnet within the slot that is based on the above-described control value are not compatible. Therefore, the unsuitable hard disk device is not able to be inserted into the slot.

At step 166, when a normal operation signal (such as a READY signal) of the mounted plug-in unit (hard disk device) is received, energization of the electromagnet in the slot is turned off. At step 167, whether or not the desired number of plug-in units (hard disk devices) has been mounted is determined. When the desired number of plug-in units (hard disk devices) has not been mounted, the procedure at steps 165, 171, 166, and 167 is repeated. Then, when determined at step 167 that the desired number of plug-in units (hard disk devices) has been mounted, the flow proceeds to step 168 and the device power is turned off. At step 169, the disk array is shipped. Whereas all of the electromagnets are turned on at step 164 in the control procedure illustrated in FIG. 16, the control procedure illustrated in FIG. 17 differ in that the electromagnets are turned on one by one by the position sensors at step 171.

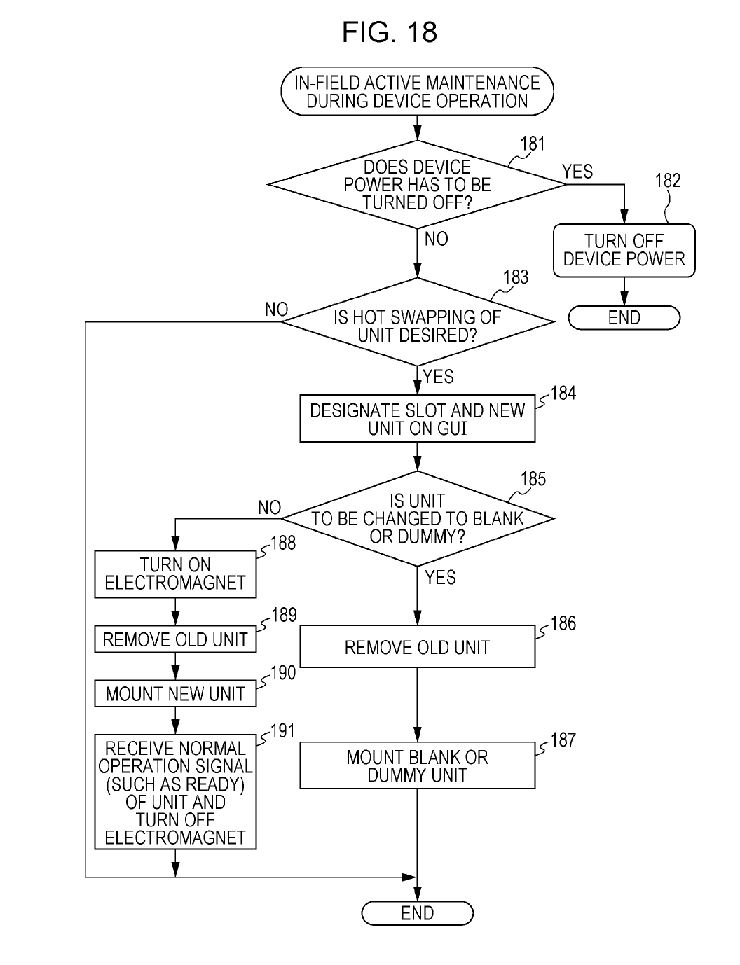

FIG. 18 is a flowchart for explaining the procedure of in-field active maintenance of the disk array of the present application when the position sensor is not provided in the slot. Active maintenance refers to an operation for replacing a hard disk device for maintenance purposes, while the disk array remains in operation. At step 181, whether or not the device power has to be turned off is determined. When the device power has to be turned off, active maintenance is not performed. Therefore, the flow proceeds to step 182 and the routine is completed without active maintenance being performed.

When the device power does not have to be turned off, the flow proceeds to step 183, and whether or not hot swapping of a hard disk device that is a plug-in unit is desired is determined. When hot swapping of a hard disk device is not desired, the routine is completed without active maintenance being performed. On the other hand, when determined at step 183 that hot swapping is desired, the flow proceeds to step 184, and a slot in which the hot swapping is to be performed and the hard disk device to be newly inserted into the slot are designated through use of a graphical interface (GUI) displayed in a display device of an input device in the disk array.

The hot swapping includes active maintenance in which a running hard disk device is removed (made blank) and active maintenance in which a running hard disk device is replaced with a dummy. Therefore, at step 185, whether a change is performed to make the hard disk device to be replaced blank, or a change is performed to replace the hard disk device with a dummy is determined. When the change to the hard disk device to be replaced is determined to be a change to blank or a change to a dummy, the flow proceeds to step 186 and the hard disk device to be replaced (old unit) is removed. At step 187, a blank or a dummy unit is mounted and the routine is completed. The dummy unit is not connected to the disk array. Therefore, the dummy is able to be inserted into the slot regardless of the electromagnet being on or off and regardless of the polarity of the magnetic field when the electromagnet is on.

On the other hand, when determined at step 185 that the change is not a change to blank or to a dummy, the flow proceeds to step 188. At step 188, all of the electromagnets of in the disk array are turned on. At step 189, the hard disk device to be replaced (old unit) is removed. At step 190, a new hard disk device (new unit) is mounted. This procedure includes a procedure for removing a plurality of hard disk devices to be replaced (old units) and mounting a plurality of new hard disk devices (new units).

At this time, when a hard disk device to be mounted in a slot is unsuitable, the polarity of the permanent magnet within the hard disk device and the polarity of the electromagnet within the slot are not compatible. Therefore, the unsuitable hard disk device is not able to be inserted into the slot. At subsequent step 191, when a normal operation signal (such as a READY signal) of the mounted hard disk device is received, energization of the electromagnet in the slot is turned off and active maintenance is completed.

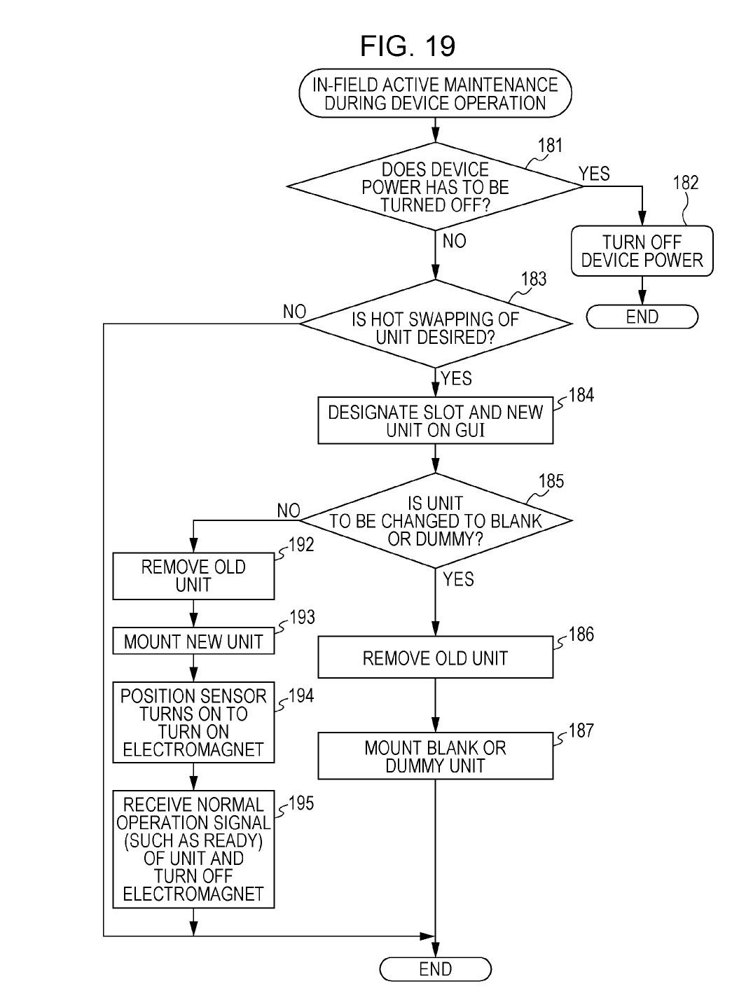

FIG. 19 is a flowchart for explaining the procedure of in-field active maintenance of the disk array of the present application when the position sensor is provided in the slot. The difference between the active maintenance procedure illustrated in FIG. 19 and the active maintenance procedure illustrated in FIG. 18 is the procedure performed when the change is not a change to blank or a change to a dummy at step 185. Therefore, the steps that are the same as those in FIG. 18 are given the same step number, and the descriptions thereof are omitted.

At step 185, when determined that the change is not a change to blank or a change to a dummy, the flow proceeds to step 192. At step 192, the hard disk device to be replaced (old unit) is removed. At step 193, a new hard disk device (new unit) is mounted in the slot. This procedure includes a procedure for removing a plurality of hard disk devices to be replaced (old units) and mounting a plurality of new hard disk devices (new units).

When a new hard disk device (new unit) is inserted into a slot at step 193, the position sensor is turned on when the hard disk device is mounted. Therefore, at step 194, the electromagnet in the slot in which the hard disk device is mounted is turned on. At this time, when a hard disk device to be mounted in a slot is unsuitable, the polarity of the permanent magnet within the hard disk device and the polarity of the electromagnet within the slot are not compatible. Therefore, the unsuitable hard disk device is not able to be inserted into the slot. At subsequent step 195, when a normal operation signal (such as a READY signal) of the mounted hard disk device is received, energization of the electromagnet in the slot is turned off and active maintenance is completed. Whereas all of the electromagnets are turned on at step 188 in the control procedure illustrated in FIG. 18, the control procedure illustrated in FIG. 19 differ in that the electromagnets are turned on one by one by the position sensors at step 194.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An apparatus for housing a plug-in unit that includes at least one movable piece including a permanent magnet in a portion of a casing, the apparatus for housing a plug-in unit comprising:
a plurality of slots, each of the plurality of slots houses the plug-in unit;
a connector provided in an inner portion of the slot and electrically connects with the plug-in unit;
an advancement blocking member disposed within the slot and blocks connection of the plug-in unit to the connector by coming into contact with the movable piece;
an electromagnet that generates a magnetic field applied to the permanent magnet of the plug-in unit; and
a control device that controls the electromagnet so as to generate a magnetic field having a predetermined polarity that moves the movable piece of the plug-in unit to a position in which the movable piece does not come into contact with the advancement blocking member.

2. The apparatus for housing a plug-in unit according to claim 1,
wherein the electromagnet is turned on when the plug-in unit is inserted into the slot.

3. The apparatus for housing a plug-in unit according to claim 1, further comprising:
a position sensor that detects insertion of the plug-in unit into the slot,
wherein the electromagnet is turned on when the position sensor detects the insertion of the plug-in unit.

4. The apparatus for housing a plug-in unit according to claim 1,
wherein electromagnets are provided in equal number to the movable pieces provided in the plug-in unit to be inserted into the slot.

5. The apparatus for housing a plug-in unit according to claim 1,
wherein, when the plug-in unit to be housed in the slot is changed and the polarity of the permanent magnet is changed, the control device changes the polarity of the electromagnet based on the changed polarity of the permanent magnet.

6. The apparatus for housing a plug-in unit according to claim 1,
wherein, when the movable piece is a rotating arm and the advancement blocking member is a pin in contact with an end portion of the movable piece, the electromagnet applies, to the permanent magnet, a magnetic field that rotates the rotating arm to a position in which the rotating arm does not come into contact with the pin.

7. The apparatus for housing a plug-in unit according to claim 6,
wherein the magnetic field applied to the permanent magnet by the electromagnet attracts the permanent magnet.

8. The apparatus for housing a plug-in unit according to claim 6,
wherein the magnetic field applied to the permanent magnet by the electromagnet repels the permanent magnet.

9. The apparatus for housing a plug-in unit according to claim 1,
wherein, when the movable piece is an emerging rod and the advancement blocking member is a pin in contact with a side surface of the emerging rod, the electromagnet applies, to the permanent magnet, a magnetic field that urges the emerging rod to move to a position in which the emerging rod does not come into contact with the pin.

10. The apparatus for housing a plug-in unit according to claim 1,
wherein, when the movable piece is a cam that includes a slit and the advancement blocking member is a pin in contact with a contour of the cam, the electromagnet applies, to the permanent magnet, a magnetic field that rotates the cam to a position in which the pin is inserted into the slit.

11. A plug-in unit to be inserted into an apparatus for housing the plug-in unit, the housing apparatus including a plurality of slots, a connector in the slot that electrically couples to the plug-in unit that is inserted into the slot, an advancement blocking member in the slot that blocks connection of the plug-in unit to the connector, and an electromagnet in the slot that applies a magnetic field to the plug-in unit, and a control device outside the slot, the control device being capable of setting the polarity of the magnetic field generated by the electromagnet, the plug-in unit comprising:
at least one movable piece that includes a permanent magnet in a portion of a casing,
wherein the movable piece is set in a position of the casing in which the permanent magnet passes through the magnetic field generated by the electromagnet when the plug-in unit is inserted into the slot and in which the movable piece comes into contact with the advancement blocking member when the movable piece is unaffected by the magnetic field; and
when the permanent magnet is affected by the magnetic field, the movable piece moves to a position in which contact with the advancement blocking member is avoided.

12. The plug-in unit according to claim 11,
wherein the movable piece is an arm capable of swinging and supported pivotally by a rotation shaft set in the casing; and
the direction of the polarity of the permanent magnet attached to the arm is the same as the direction of the magnetic field.

13. The plug-in unit according to claim 11,
wherein the movable piece is a rod capable of emerging, from a case set in the casing, perpendicularly to a direction in which the plug-in unit is inserted into and removed from the slot,
the rod projects from the case when the rod is not affected by the magnetic field, and
the direction of the polarity of the permanent magnet attached to the rod is the same as the direction of the magnetic field.

14. An apparatus for housing a plug-in unit that includes at least one movable piece including a permanent magnet in a portion of a casing, the apparatus for housing a plug-in unit comprising:
a plurality of slots, each of the plurality of slots houses the plug-in unit;
a connector provided in an innermost portion of the slot and electrically connects with the plug-in unit;
an advancement blocking member disposed within the slot and blocks connection of the plug-in unit to the connector by coming into contact with the movable piece;
an electromagnet that generates a magnetic field applied to the permanent magnet of the plug-in unit; and
a control device that controls the electromagnet so as to generate a magnetic field having a predetermined polarity that moves the movable piece of the plug-in unit to a position in which the movable piece does not come into contact with the advancement blocking member.
